(19) United States
(12) Patent Application Publication
(10) Pub. No.: US 2011/0274444 A1
(43) Pub. Date: Nov. 10, 2011

(54) IMAGE FORMING APPARATUS AND IMAGE FORMING METHOD

(75) Inventor: Takahiro Nakajima, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/084,634

(22) Filed: Apr. 12, 2011

Related U.S. Application Data
(60) Provisional application No. 61/331,137, filed on May 4, 2010.

(51) Int. Cl. G03G 15/08

(52) U.S. Cl. 399/12; 399/28; 399/27

(57) ABSTRACT

An image forming apparatus includes an image forming unit including a developing device, a toner cartridge to supply a toner to the developing device, a first memory which is provided in the toner cartridge and in which data of a toner characteristic is previously stored, a toner use amount detection mechanism to detect a parameter value for obtaining a toner use amount, a second memory which is provided in the image forming unit and in which the parameter value and a threshold of a toner use amount for performing a toner replacement operation are stored, and an arithmetic control mechanism which obtains the toner use amount based on the parameter value, compares the toner use amount with the threshold, determines necessity of the toner replacement operation, and executes the toner replacement operation based on the characteristic data.

### CROSS-REFERENCE TO RELATED APPLICATION

This application is based upon and claims the benefit of priority from the prior U.S. Patent Application No. 61/331,137 filed on May 4, 2010, the entire contents of which are incorporated herein by reference.

### FIELD

Embodiments described herein relate generally to an image forming apparatus and an image forming method.

### BACKGROUND

In general, in order to stabilize image characteristics in electrophotography, an image forming condition is controlled based on information from a toner density sensor, an optical sensor, a temperature and humidity sensor or the like.

On the other hand, when toner in a developing device is not consumed for the volume of copy, or the agitating time of the toner and carrier becomes long, the toner electric charge increases, and defects, such as reduction in image density and fogging, occur. Against such a phenomenon, the amount of toner consumed for a specific period is estimated from a copy counter, a developing device drive counter, a pixel counter or the like. When the replacement amount of toner is low as compared with the estimated toner amount, after a copy job is ended, the toner is forcibly discharged. In this way, the highly charged toner is discharged, and a new toner is supplied, so that stable image formation can be performed.

However, according to the forcible discharge of toner as stated above, there is a problem that a large amount of toner, which is not printed on a transfer medium, is discarded, the replacement frequency of a toner cartridge becomes high, and the running cost becomes high.

### BRIEF DESCRIPTION OF THE DRAWINGS

FIG. 1 is a structural view of an image forming apparatus as a four-drum tandem color printer of an embodiment;

FIG. 2 is a schematic structural view of an image forming unit of the embodiment;

FIG. 3 is a block diagram of the embodiment;

FIG. 4 is a table of addresses and information content of a memory on a body side;

FIG. 5 is a table of addresses and information content of a memory on a toner cartridge side; and

FIG. 6 is a flowchart of the embodiment.

### DETAILED DESCRIPTION

Reference will now be made in detail to the present embodiment of the invention, an example of which is illustrated in the accompanying drawing.

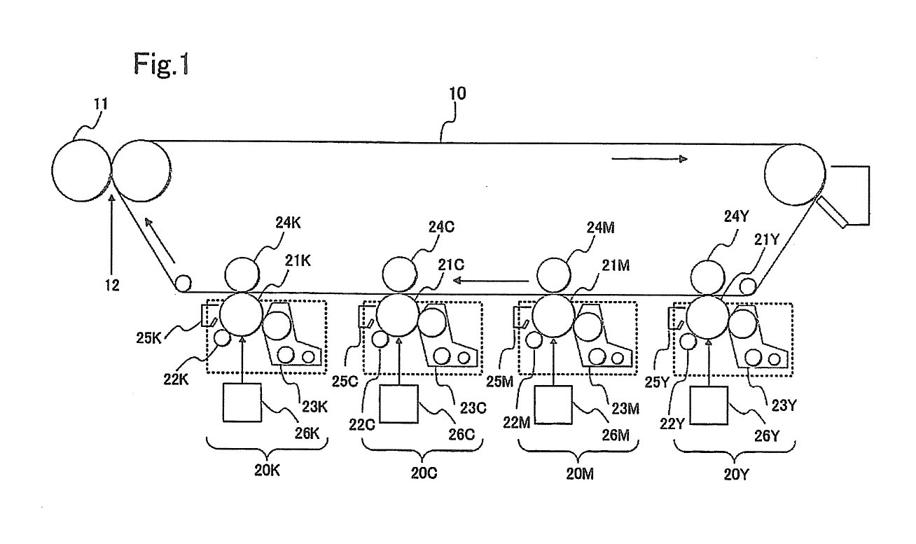

FIG. 1 is a structure view of an image forming apparatus of a four-drum tandem color printer, which is an example of an image forming apparatus of an embodiment. As shown in FIG. 1, a secondary transfer roller 11 to transfer an image on an intermediate transfer belt 10 onto a transfer medium 12, and respective image forming units 20Y, 20M, 20C and 20K of yellow, magenta, cyan and black are arranged along the conveyance direction (arrow direction) of the intermediate transfer belt 10.

The image forming units 20Y, 20M, 20C and 20K include photoreceptors 21Y, 21M, 21C and 21K as image carriers. Further, charging devices 22Y, 22M, 22C and 22K as charging portions, developing devices 23Y, 23M, 23C and 23K including developing rollers as developing members and having developers including color toner particles of yellow, magenta, cyan and black and carrier particles, primary transfer rollers 24Y, 24M, 24C and 24K as transfer portions, and cleaner units 25Y, 25M, 25C and 25K are provided around the respective photoreceptors. These are respectively arranged along the rotation directions of the corresponding photoreceptors 21Y, 21M, 21C and 21K.

The primary transfer rollers 24Y, 24M, 24C and 24K are disposed inside the intermediate transfer belt 10, and nip the intermediate transfer belt 10 against the corresponding photoreceptors 21Y, 21M, 21C and 21K. Exposure devices 26Y, 26M, 26C and 26K are arranged so that exposure points are formed on the outer peripheral surfaces of the photoreceptors 21Y, 21M, 21C and 21K between the charging devices 22Y, 22M, 22C and 22K and the developing devices 23Y, 23M, 23C and 23K. The secondary transfer roller 11 is arranged outside the intermediate transfer belt 10 so as to contact therewith.

A print operation is performed as described below by the image forming apparatus constructed as stated above. A toner image is formed in the image forming unit 20Y. The same process is performed also in the image forming units 20M, 20C and 20K in synchronization with the timing of the toner image formation in the image forming unit 20Y. The toner images of magenta, cyan and black formed on the photoreceptors of the image forming units 20M, 20C and 20K are also sequentially primarily transferred onto the intermediate transfer belt 10.

The transfer medium 12 is conveyed from a cassette (not shown), and is sent to the intermediate transfer belt 10 by an aligning roller (not shown) in timing with the toner images on the intermediate transfer belt 10.

A bias (+) of a reverse polarity to a charging polarity of a toner is applied to the secondary transfer roller 11 by a power source (not shown). As a result, the toner images on the intermediate transfer belt 10 are transferred onto the transfer medium 12 by a transfer electric field formed between the intermediate transfer belt 10 and the secondary transfer roller 11. A fixing device (not shown) to fix the toner transferred onto the transfer medium 12 is disposed, and the transfer medium 12 is made to pass through the fixing device so that a fixed image is obtained.

Incidentally, although the description is made on the example in which the image forming units are arranged in color sequence of yellow, magenta, cyan and black, the color sequence is not limited.

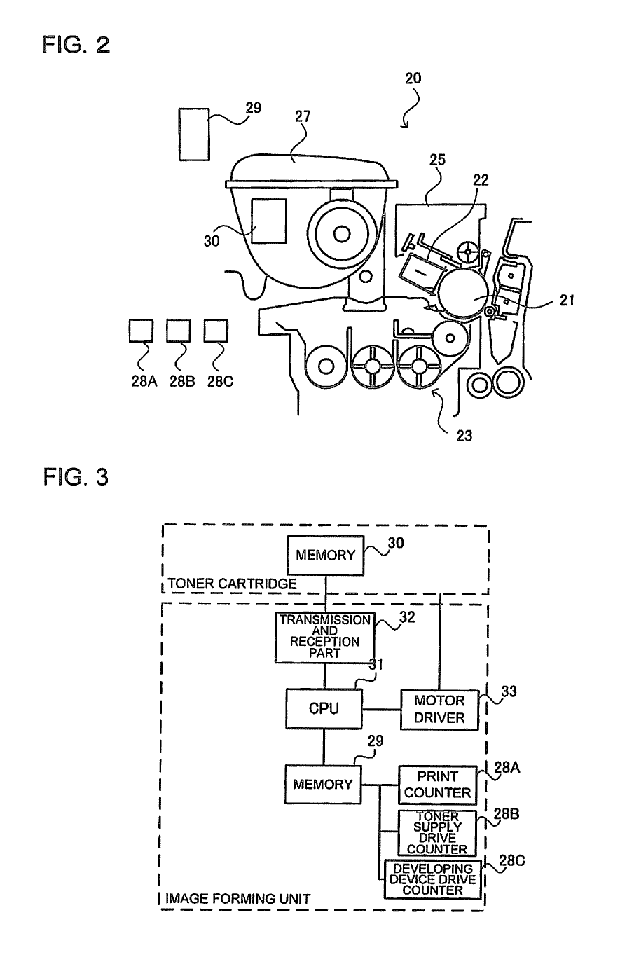

FIG. 2 is a schematic structural view of an image forming unit in the image forming apparatus which is constructed as stated above and in which an image is formed. Incidentally, the image forming units 20Y, 20M, 20C and 20K have the same structure.

As shown in FIG. 2, a charging charger 22, a developing device 23 and a cleaning unit 25 are arranged around a photoreceptor 21. A toner cartridge 27 is mounted on the developing device 23. Further, a print counter 28A to count the number of prints, output pixels or the like, a toner supply drive counter 28B to count the drive time of the toner cartridge, and a developing device drive counter 28C to count the drive time of the developing device 23 are installed.

Further, the image forming unit 20 includes a memory 29 in which values of the print counter 28A, the toner supply drive counter 28B and the developing device drive counter 28C and a threshold used to determine the necessity of a toner replacement operation are stored.

The toner cartridge 27 includes a memory 30 in which characteristic data of a manufacturing lot of toner stored in the toner cartridge 27 is previously stored. Incidentally, the memory 30 is not necessarily required to be attached to the toner cartridge 27. The memory may be attached to an integrated unit of a developing unit including the toner cartridge 27 and the developing device. Besides, the memory 30 may be separated and mounted on the image forming unit.

The respective components of the image forming unit are connected to an arithmetic control mechanism (not shown) to control these.

In the image forming unit as stated above, the control of a forcible toner supply operation is performed as described below. FIG. 3 is a block diagram of a component portion in which the control of a toner replacement operation is performed. As shown in FIG. 3, a CPU 31 as an arithmetic control mechanism is connected to the memory 29 of the image forming unit 20. The memory 29 is connected to the print counter 28A, the toner supply drive counter 28B and the developing device drive counter 28C.

Further, the CPU 31 is connected to the memory 30 of the toner cartridge 27 through a transmission and reception part 32 via wired or wireless, and controls the image forming apparatus including the respective components of the image forming unit 20 such as a toner cartridge drive motor 33. Incidentally, the CPU 31 is not required to be integrated, and may be separate from a motor driver to drive the toner cartridge drive motor 33, an ASIC to process data from the memory 29, an ASIC to process data from the memory 30, or the like. Besides, the memory 29 may be incorporated.

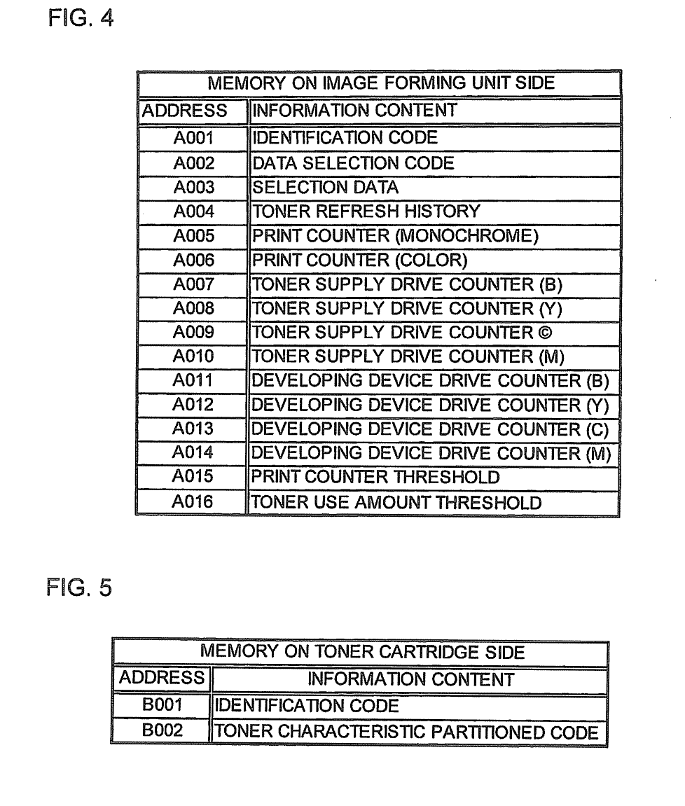

FIG. 4 shows a correspondence table of addresses and information content of the memory 29 on the image forming unit side, and FIG. 5 shows a correspondence table of addresses and information content of the memory 30 on the toner cartridge side.

As shown in the table of FIG. 4, the memory 29 on the image forming unit side includes, for the respective addresses, an area (A001) in which an identification code is inputted, an area (A002) in which a data selection code for selecting a toner replacement amount according to an after-mentioned toner characteristic partitioned code is inputted, a writing area (A003) in which a characteristic partitioned code from the memory 30 on the toner cartridge 27 side is written, and a toner refresh history writing area (A004) in which history of execution of the toner replacement operation is written. Besides, print counter value writing areas (A005, A006) in which print counter values in a monochrome mode and a color mode are respectively written are provided.

There are provided a toner supply drive counter value writing areas (A007-A010) in which counter values of drive times of the respective toner cartridges of black, yellow, cyan and magenta are written, and a developing device drive counter value writing area (A011-A014) in which counter values of drive times of the respective developing devices are written. These count values are respectively parameter values for obtaining the use amount of toner.

Further, there are provided a writing area (A015) of print count thresholds which are respectively thresholds for executing the toner replacement operation, and a writing area (A016) of a toner refresh threshold as a threshold for the toner use amount obtained from the parameter values detected by the toner supply drive counter 28B and the developing device drive counter 28C.

Besides, as shown in the table of FIG. 5, the memory 30 on the toner cartridge 27 side includes, for respective addresses, an area (B001) in which an identification code is inputted and an area in which a partitioned code partitioned based on a toner resistance value as a toner characteristic is inputted. Incidentally, as the toner characteristic, a charge amount, a particle diameter or the like can be used in addition to the toner resistance value. Besides, the characteristic value itself is inputted, and may be partitioned by the CPU 31, or may be inputted as a partitioned code of toner replacement amount.

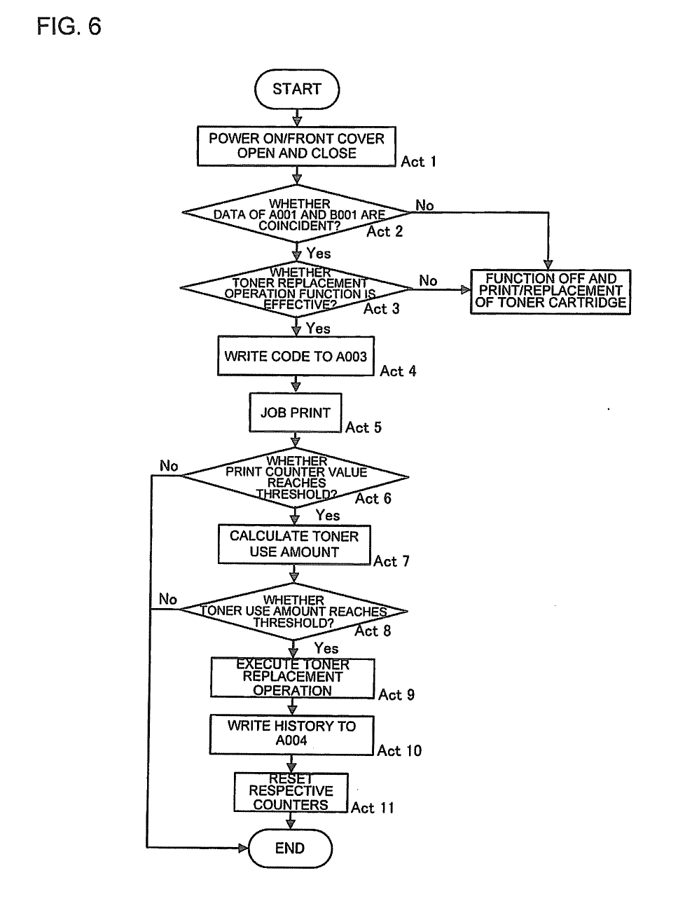

By the structure as stated above, the control of the toner replacement operation is performed as described below. FIG. 6 shows a flowchart. As shown in FIG. 6, when printing starts, power supply is turned ON, or a front cover is opened and closed in order to replace the toner cartridge (Act 1). It is determined whether an identification code inputted in A001 of the memory 29 and an identification code inputted in B001 of the memory 30 are coincident with each other (Act 2). When they are coincident, it is determined whether a toner replacement operation (toner refresh) function in the image forming apparatus body is effective (Act 3). When it is effective, the following operation is performed. When the identification codes are not coincident, and when the toner replacement operation function is ineffective, a print operation in which the function is stopped is performed or the toner cartridge is replaced.

The partitioned code written in B002 is read into the CPU 31 through the transmission and reception part 32, and the corresponding control code of A002 is selected and is written to A003 (Act 4). By this, the image forming apparatus body is place in a Ready state, and a print job is performed (Act 5).

After the print job is ended, it is determined whether the print counter values written in A005 and A006 reach the print counter thresholds written in A015 (Act 6).

When they reach the print counter thresholds, the toner use amount is obtained from the toner supply drive counter values written in A007-A010 and the developing device drive counter values written in A011-A014 (Act 7). It is determined whether the obtained toner use amount reaches the toner refresh threshold written in A016 (Act 8).

When it reaches the toner refresh threshold, the toner replacement operation is executed based on the control code written in A003 (Act 9). The execution history is written to A004 (Act 10), and the counter values of the print counter 28A, the toner supply drive counter 28B and the developing device drive counter 28C are reset (Act 11).

As described above, in the toner replacement operation, although a constant amount of toner is discharged and supplied until now, the control can be performed so that the discharge amount (supply amount) is adjusted according to, for example, the charging characteristic of toner, and the use amount of toner can be suppressed.

While certain embodiments have been described, these embodiments have been presented by way of example only, and are not intended to limit the scope of the inventions. Indeed, the novel embodiments described herein may be embodied in a variety of other forms; furthermore, various omission, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit including a developing device;
a toner cartridge configured to supply a toner to the developing device;
a first memory which is provided in the toner cartridge and in which data of a toner characteristic is previously stored;
a toner use amount detection mechanism configured to detect a parameter value for obtaining a toner use amount;
a second memory which is provided in the image forming unit and in which the parameter value and a threshold of a toner use amount for performing a toner replacement operation are stored; and
an arithmetic control mechanism which obtains the toner use amount based on the parameter value, compares the toner use amount with the threshold, determines necessity of the toner replacement operation, and executes the toner replacement operation based on the characteristic data.

2. The apparatus of claim 1, wherein the toner characteristic is a toner physical property having an influence on a charging characteristic.

3. The apparatus of claim 2, wherein the toner physical property is at least one of a toner resistance value, a charging amount and a particle diameter.

4. The apparatus of claim 1, wherein the data of the toner characteristic is a partitioned code partitioned based on the toner characteristic.

5. The apparatus of claim 4, wherein the arithmetic control mechanism selects a toner replacement amount based on the partitioned code.

6. The apparatus of claim 1, wherein the arithmetic control mechanism obtains a toner replacement amount based on the data of the toner characteristic.

7. The apparatus of claim 1, wherein the data of the toner characteristic is a toner replacement amount obtained from the toner characteristic.

8. The apparatus of claim 1, wherein the toner use amount detection mechanism is a detecting counter of at least one of a print counter, a toner supply drive counter and a developing device drive counter.

9. The apparatus of claim 1, further comprising the image forming units of black, yellow, magenta and cyan, wherein
in the arithmetic control mechanism of at least one of the image forming units of black, yellow, magenta and cyan, when it is determined that the toner replacement operation is necessary, the toner replacement operation is executed.

10. The apparatus of claim 1, wherein identification codes are previously inputted in the first memory and the second memory.

11. The apparatus of claim 1, further comprising a transmission and reception part to connect the first memory and the arithmetic control mechanism via wired or wireless.

12. An image forming method, comprising:
supplying, in an image forming unit, a toner, on which data of a toner characteristic is previously stored, to a developing device from a toner cartridge to perform a specified print operation;
detecting a parameter value for obtaining a use amount of the toner;
determining that a toner replacement operation is necessary when the parameter value reaches a previously inputted threshold of the parameter for performing the toner replacement operation; and
executing the toner replacement operation based on the data of the toner characteristic.

13. The method of claim 12, wherein the toner characteristic is a toner physical property having an influence on a charging characteristic.

14. The method of claim 13, wherein the toner physical property is at least one of a toner resistance value, a charging amount and a particle diameter.

15. The method of claim 12, wherein the data of the toner characteristic is a partitioned code partitioned based on the toner characteristic.

16. The method of claim 15, wherein a toner replacement amount is selected based on the partitioned code.

17. The method of claim 12, wherein a toner replacement amount is obtained based on the data of the toner characteristic.

18. The method of claim 12, wherein the data of the toner characteristic is a toner replacement amount obtained from the toner characteristic.

19. The method of claim 12, wherein the parameter value is at least one of the number of prints or output pixels, a drive time of the toner cartridge and a drive time of the developing device.

20. The method of claim 12, wherein the image forming units of black, yellow, magenta and cyan are provided,
when it is determined that the toner replacement operation of at least one of the yellow, the magenta and the cyan image forming unit is necessary, the toner replacement operation is executed.
